(19) United States
(12) Patent Application Publication
(10) Pub. No.: US 2011/0081940 A1
(43) Pub. Date: Apr. 7, 2011

(54) Methods and Arrangements For Uplink Multicarrier Power Control in a Wireless Communications System

(76) Inventors: Dirk Gerstenberger, Stockholm (SE); Samuel Axelsson, Stocksund (SE)

(21) Appl. No.: 12/922,299

(22) PCT Filed: Dec. 16, 2008
(86) PCT No.: PCT/SE2008/051468

§ 371 Date: Dec. 8, 2010

Related U.S. Application Data
(60) Provisional application No. 61/036,133, filed on Mar. 13, 2008.

(51) Int. Cl. H04W 52/00

(52) U.S. Cl. 455/522

(57) ABSTRACT

A method of uplink transmit power control in a radio base station of a multi-carrier wireless communication system, in which the radio base station communicated with user equipment on N uplink carriers and M downlink carriers, with the sum of N and M being at least three, includes defining N transmit power control (TPC) commands to be used by the user equipment for adjusting the transmit power of the N uplink carriers. The method also includes transmitting both a first and at least a second of said N TPC commands on a first downlink carrier and each of the remaining TPC commands on separate subsequent downlink carriers, in order to fit all N TPC commands onto the M downlink carriers when M is smaller than N. The method further includes transmitting each of said N TPC commands on separate downlink carriers, when M is larger than or equal to N.

### TECHNICAL FIELD

The present invention relates to the area of wireless communications, and especially to uplink power control in a multi-carrier Universal Mobile Telecommunication System. More specifically, the invention relates to a method of uplink power control in a radio base station and in a user equipment, as well as to a radio base station and a user equipment.

### BACKGROUND

The Universal Mobile Telecommunication System (UMTS), also referred to as the third generation (3G) system or the wideband code division multiplexing access (WCDMA) system, is designed to succeed GSM. UMTS Terrestrial Radio Access Network (UTRAN) is the radio access network of a UMTS system.

High-Speed Downlink Packet Access (HSPDA) is an evolution of UTRAN bringing further enhancements to the provisioning of packet-data services both in terms of system and end-user performance. The downlink packet-data enhancements of HSDPA are complemented with Enhanced Uplink (EUL), also known as High-Speed Uplink Packet Access (HSUPA). EUL provides improvements in the uplink capabilities and performance in terms of higher data rates, reduced latency, and improved system capacity, and is therefore a natural complement to HSDPA. HSDPA and EUL are often jointly referred to as High-Speed Packet Access (HSPA). In the HSPA architecture, a user equipment (UE) 150 is wirelessly connected to a radio base station, i.e. a NodeB 130, as illustrated in FIG. 1.

The operation of WCDMA/HSPA on multiple 5 MHz frequency blocks—so called carriers—used simultaneously for one given UE, is one further step of evolving WCDMA and HSPA. This mode of operation is often referred to as multi-carrier HSPA.

A multi-carrier connection with frequency division duplex (FDD) can be described as a set of downlink carriers linked to a set of uplink carriers for a given UE. The downlink carriers can be adjacent or non-adjacent in the frequency domain, and the same holds for the uplink carriers. More generally speaking, the carriers do not need to be in the same frequency band, and time division duplex (TDD) bands could also be used as part of the multi-carrier operation. The number of downlink carriers may also be different from the number of uplink carriers in a multi-carrier connection for a given UE. If there is one uplink carrier, the number of downlink carriers can for example be two or more. The opposite with more uplink carriers than downlink carriers is also possible. Hereinafter, the “multi-carrier symmetry” of a connection refers to the number of uplink and downlink carriers in the multi-carrier connection for a given UE.

Conventionally, one anchor carrier can be defined in uplink and one in downlink, in a multi-carrier connection. The remaining carriers (uplink and downlink) can then be referred to as non-anchor (NA) carriers. For example, most of the control signaling can be carried on the anchor carrier, while the non-anchor carriers carry only the data channels and necessary control signaling channels that cannot be carried on the anchor carrier.

In prior art, WCDMAIHSPA systems make use of a mechanism to control the uplink power, in which transmit power control (TPC) commands are defined by the NodeB based on measurements of the signals received from the UE. The TPC command can indicate either “up” corresponding to a power increase of e.g. 1 dB, or “down” corresponding to a power decrease. The TPC commands are transmitted on the fractional downlink physical control channel (F-DPCH) in order for the UE to adjust the uplink transmit power. This mechanism is used both in soft handover and non-soft handover scenarios. In soft handover several radio base stations, i.e. NodeBs, are transmitting TPC commands to a single user equipment, so the user equipment needs to combine the different TPC commands according to a defined combination rule.

In a conventional multi-carrier HSPA system, there can be different multi-carrier symmetries with multiple downlink carriers and/or multiple uplink carriers for a given UE, as described above. The different carriers may use adjacent or non-adjacent frequency bands. A multi-carrier system also operates in soft handover scenarios. In all multi-carrier systems, there is a need to control the transmission power of the uplink carriers. Uplink power control mechanisms has to be defined, going beyond the mechanisms used in single-carrier systems with only one uplink and one downlink carrier, e.g. because channel conditions may differ between different (potentially non-adjacent) uplink carriers. Thus, there is a need to provide an efficient and reliable control of the uplink transmit power in a multi-carrier HSPA system, regardless of e.g. the multi-carrier symmetry and the used frequency bands for the different carriers.

### SUMMARY

The object of the present invention is to address the problem outlined above, and this object and others are achieved by the method and the arrangement according to the appended independent claims, and by the embodiments according to the dependent claims.

A basic concept of the invention is to adapt the TPC command mechanism for uplink transmit power control, used in single-carrier systems, to support different kinds of multi-carrier scenarios, including the different soft-handover scenarios.

Thus in accordance with a first aspect of the present invention, a method of uplink transmit power control in a radio base station of a multi-carrier wireless communication system is provided. The radio base station receives on N uplink carriers and transmits on M downlink carriers in the communication with at least one user equipment, where the sum of N and M is equal to or larger than three. The method is characterised by the step of defining at least one TPC command to be used by one of the user equipment for adjusting the transmit power of the N uplink carriers, the number of defined TPC commands being equal to or lower than N, and the step of transmitting the defined at least one TPC command on at least one of the M downlink carriers.

In accordance with a second aspect of the present invention, a method of uplink transmit power control in a user equipment of a multi-carrier wireless communication system is provided. The user equipment transmits on N uplink carriers and receives on M downlink carriers in the communication with at least one radio base station, where the sum of N and M is equal to or larger than three. The method is characterised by the step of receiving at least one TPC command on at least one of the M downlink carriers from at least one radio base station, the number of received TPC commands being equal to or lower than N, and the step of adjusting the transmit power of the N uplink carriers based on the received at least one TPC command.

In accordance with a third aspect of the present invention, a radio base station of a multi-carrier wireless communication system is provided. The radio base station is arranged to receive on N uplink carriers and transmit on M downlink carriers in the communication with at least one user equipment, where the sum of N and M is equal to or larger than three. The radio base station is characterised in that it comprises means for defining at least one TPC command to be used by one of the user equipment for adjusting the transmit power of the N uplink carriers, the number of defined TPC commands being equal to or lower than N, and means for transmitting the defined at least one TPC command on at least one of the M downlink carriers.

In accordance with a fourth aspect of the present invention, a UE of a multi-carrier wireless communication system is provided. The user equipment is arranged to transmit on N uplink carriers and receive on M downlink carriers in the communication with at least one radio base station, where the sum of N and M is equal to or larger than three. The user equipment is characterised in that it comprises means for receiving at least one TPC command on at least one of the M downlink carriers from at least one radio base station, the number of received TPC commands being equal to or lower than N, and means for adjusting the transmit power of the N uplink carriers based on the received at least one TPC command.

An advantage of the embodiments of the present invention is that they provide a solution for uplink power control in a multi-carrier system. Another advantage of the embodiments of the present invention is that the different downlink carriers are used in a way that optimizes the reliability of the power control commands in the case of frequency selective downlink channel conditions.

### BRIEF DESCRIPTION OF THE DRAWINGS

FIG. 1 illustrates schematically a part of a single- or multi-carrier WCDMA/HSPA system.

FIG. 2a-2f illustrates schematically different embodiments of the present invention applied in some examples of multi-carrier connections with different carrier symmetries.

FIGS. 3a-3f are flowcharts of the methods of the NodeB and the UE according to different embodiments of the present invention.

FIG. 4 illustrates schematically the NodeB and UE according to embodiments of the present invention.

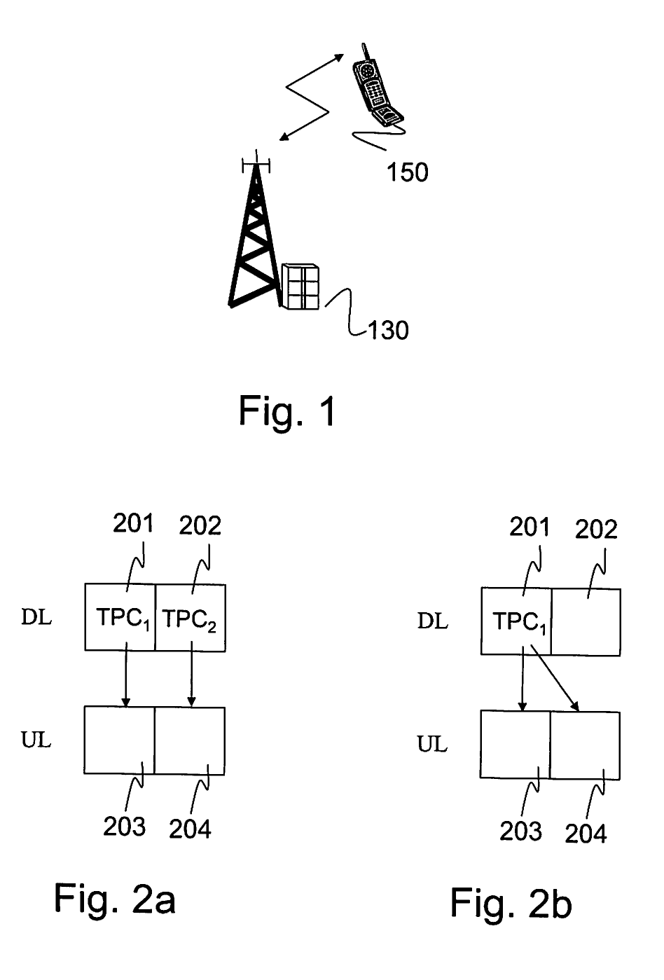

### DETAILED DESCRIPTION

In the following, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it will be apparent to one skilled in the art that the present invention may be practised in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

The present invention is described herein by way of reference to particular example scenarios. In particular the invention is described in a non-limiting general context in relation to a multi-carrier HSPA system. It should though be noted that the invention and its exemplary embodiments may also be applied to other types of radio access technologies with similar characteristics to HSPA in terms of power control, such as LTE, WiMAX and UTRA TDD. Furthermore, the present invention is described with the help of examples of different multi-carrier symmetries. However, the present invention is not limited to these examples. Any other multi-carrier symmetry will also be supported, regardless of the number of uplink and downlink carriers in a system.

The present invention relates to methods and arrangements that enable control of the uplink transmit power in a multi-carrier HSPA system. This is achieved by using the concept of TPC commands (used in single-carrier systems), adapted to support different kinds of multi-carrier scenarios, including the soft handover scenarios. An object is to provide an efficient and reliable uplink power control mechanism for multi-carrier systems, regardless of e.g. the multi-carrier symmetry and the used frequency bands for the different carriers.

In the present invention, one or more TPC commands are defined in the NodeB to control the transmit power of the uplink carriers, based on measurements of the signals from the UEs. These TPC commands are then transmitted on the downlink carriers to the UE in different ways depending on the number of downlink carriers and on the number of defined TPC commands. The UE will receive the TPC command(s) and adjust the uplink power in different ways depending on the type of TPC command(s) and the multi-carrier symmetry.

In a first embodiment of the present invention, the TPC commands are transmitted on one or more downlink control channels on the downlink carriers. In an exemplary embodiment of this first embodiment, the downlink control channel is the F-DPCH. If more than one TPC command is to be transmitted on one downlink carrier (this case is further explained below), then each TPC command is mapped on a separate F-DPCH on that carrier. In an alternative embodiment of this first embodiment, a new control channel is defined that can carry more than one TPC commands. However, in all the exemplary embodiments described hereinafter, the F-DPCH will be used for carrying TPC commands.

One main principle of the present invention is that the number of TPC commands that are defined and transmitted on the downlink shall be equal to or less than the number of uplink carriers to control. This means that for the case of one uplink carrier and two or more downlink carriers, only one TPC command shall be defined and transmitted on the downlink (i.e. on one or more downlink carriers) to control the uplink. In the case of multiple uplink carriers, the following two alternative embodiments are possible.
1. One TPC command per uplink carrier is defined and transmitted, in order for the UE to adjust the power of each uplink carrier separately. The number of TPC commands thus corresponds to the number of uplink carriers.
2. One single common TPC command—i.e. common for all uplink carriers—is defined and transmitted in order for the UE to adjust the power of all the uplink carriers in the same way. In this embodiment, there are different alternatives on how to define the common TPC command. In a first alternative embodiment A, a TPC command valid for one of the uplink carriers, e.g. the anchor carrier, is used to power control all uplink carriers in the same way. In a second alternative embodiment B, the different TPC commands valid for all the uplink carriers are combined according to some pre-defined combination rule. In one embodiment the pre-defined combination rule is the “or of down” rule, stating that the combined value indicates “up” when all TPC commands indicate “up”, and indicates “down” if at least one of the TPC commands indicates “down”. In an alternative embodiment the pre-defined combination rule is the “or of up” rule, stating that the combined value indicates “down” when all TPC commands indicate “down”, and indicates “up” if at least one of the TPC commands indicates “up”.

A combination of the alternative embodiments 1 and 2 above is also possible, by using alternative embodiment 1 for one group of uplink carriers, and alternative embodiment 2 for the rest of the uplink carriers. In the example with three uplink carriers and two downlink carriers, one TPC command is defined to control the power of the two first uplink carriers jointly (according to alternative embodiment 2 above) and one TPC command is defined to control the third uplink carrier separately (according to alternative embodiment 1 above) for instance.

The transmission of the TPC command(s) may also vary with the different multi-carrier symmetries, as it depends on the number of available downlink carriers. In the case of alternative embodiment 1 above, there are three different alternatives for the transmission of the TPC commands, depending on if the number of downlink carriers M is larger than, smaller than, or equal to the number of uplink carriers N to power control. The number of uplink carriers N corresponds to the number of defined TPC commands to transmit. The three alternatives are described below:
i. When the number of downlink carriers M is equal to or larger than the number of uplink carriers N to control, each TPC command is transmitted on a separate downlink carrier.
ii. However, when the number of downlink carriers M is larger than the number of uplink carriers N to control, one TPC command (e.g. the TPC command for the anchor uplink carrier) may be transmitted on more than one downlink carrier to control one of the uplink carriers. The UE will then adjusts the uplink transmit power for the uplink carrier according to a combination of the commands received on the different downlink channels. The combination may be a soft combination using weight factors which are either fixed or set according to the estimated downlink channel conditions on respective carrier. The advantage of this alternative is that the reliability of the uplink power control is improved in case of frequency selective downlink channel conditions. In soft handover, the UE will receive the same TPC command on several carriers but also from more than one NodeB (i.e. from all NodeBs involved in the soft handover). In one exemplary embodiment, the combination (according to a pre-defined combination rule) of the TPC values received from the different NodeBs is done before the soft combination of the TPC values on the different downlink carriers. In an alternative exemplary embodiment, the different carrier values are combined before combining the values from the different NodeBs. In one embodiment, the pre-defined combination rule is the “or of down” rule as defined above.
iii. When the number of downlink carriers M is smaller than the number of uplink carriers N to control, more than one TPC command is to be transmitted on one downlink carrier in order to be able to fit all TPC commands on the downlink carriers.

In the case of alternative embodiment 2 above with only one TPC command to transmit, there will always be an available downlink carrier to use for the transmission. However, if there are more than one downlink carriers, the reliability of the power control can be increased in case of frequency selective downlink channel conditions, according to a further exemplary embodiment, by transmitting the TPC command on more than one downlink carrier. The UE will then adjust the uplink transmit power for the uplink carrier according to a combination of the commands received on the different downlink channels. The combination may be a soft combination using weight factors which can be either fixed or set according to the estimated downlink channel conditions on respective carrier.

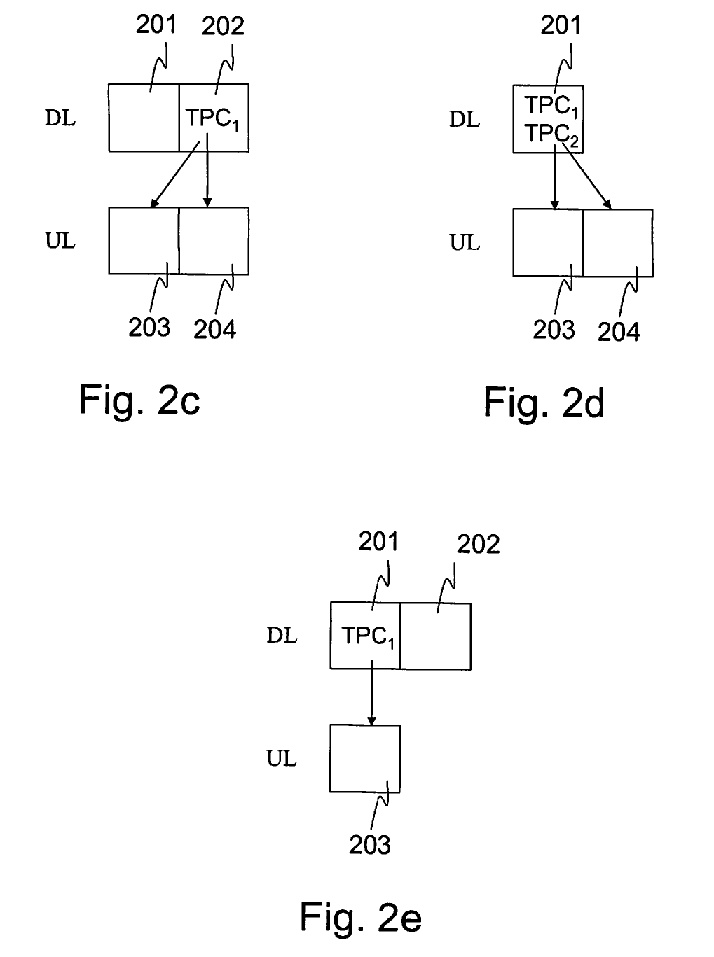

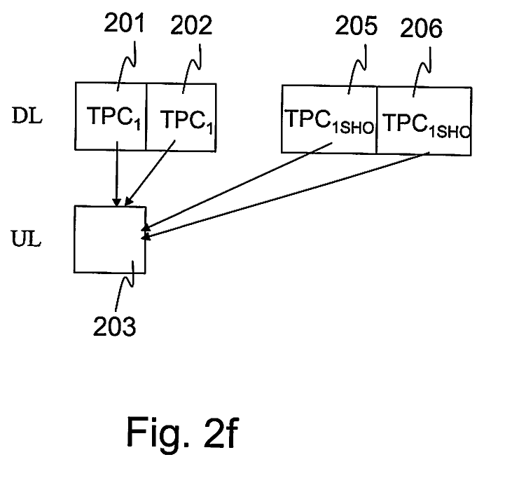

In the following, the above embodiments will be further explained with reference to FIGS. 2a-2f. In the figures, downlink is abbreviated DL and uplink is abbreviated UL.

Starting with the alternative embodiment 1 above, and supposing a multi-carrier symmetry with two uplink carriers (one anchor carrier (A) 203 and one non-anchor carrier (NA) 204) and two downlink carriers (one anchor carrier (A) 201 and one non-anchor carrier (NA) 202), FIG. 2a illustrates how one TPC command (TPC₁) transmitted on the F-DPCH of the anchor downlink carrier 201 is used by the UE to adjust the transmit power of the anchor uplink carrier 203, and one TPC command (TPC₂) transmitted on the F-DPCH of the non-anchor downlink carrier 202 is used by the UE to adjust the transmit power of the non-anchor uplink carrier 204. In the case of soft handover, the UE combines the TPC commands received from different soft handover cells according to the “or of down” rule.

Power control in a system supposing the same example of multi-carrier symmetry as above with the alternative embodiment 2, and with the common TPC command defined according to any of the two alternatives A or B described above, is schematically illustrated in FIG. 2b. The TPC command TPC₁ is transmitted on the F-DPCH of the anchor downlink carrier 201, in order for the UE to adjust the transmit power of both the anchor 203 and the non-anchor uplink carrier 204 in the same way. If TPC₁ indicates “up”, then the transmit power of both uplink carriers 203, 204 are adjusted by a power step “up”. In case of soft handover, the UE combines the TPC commands received from different soft handover cells according to the “or of down” rule. The TPC₁ command may also be transmitted on the non-anchor downlink carrier 202 instead, as illustrated in FIG. 2c. It is also possible, as discussed above, to transmit the TPC₁ command on both the anchor 201 and the non-anchor downlink carrier 202, in order to improve the reliability of the uplink power control in case of frequency selective downlink channel conditions.

FIG. 2d illustrates the case of the alternative embodiment 1, supposing a multi-carrier symmetry with two uplink (one anchor 203 and one non-anchor carrier 204) and one downlink carrier 201. Two TPC commands (TPC₁ and TPC₂) are transmitted on separate F-DPCH of the same downlink carrier 201, as described above. The UE adjusts the transmit power of the anchor uplink carrier 203 according to the TPC command TPC₁ received on the first F-DPCH of the anchor downlink carrier 201, and adjusts the transmit power of the non-anchor uplink carrier 204 according to the TPC command TPC₂ received on the second F-DPCH of the anchor downlink carrier 201.

FIG. 2e-2f illustrates the case of a multi-carrier symmetry with two downlink carriers (one anchor 201 and one non-anchor carrier 202) and one uplink carrier 203. In this case there will only be one TPC command, as there is only one uplink carrier to control, so there is no difference between alternative embodiment 1 and 2. The TPC command TPC₁ is in FIG. 2e transmitted on the F-DPCH of the anchor downlink carrier 201, in order for the UE to adjust the uplink carrier. In case of soft handover, the UE combines the TPC commands received from different soft handover cells according to the “or of down” rule. It is also possible to transmit TPC₁ on the F-DPCH of the non-anchor downlink carrier 202 instead.

In order to improve the reliability of the uplink power control in case of frequency selective downlink channel conditions, and according to FIG. 2f, the TPC command TPC₁ is transmitted both on the F-DPCH of the non-anchor downlink carrier 202 and on the F-DPCH of the anchor downlink carrier 201. The UE will then adjust the uplink transmit power for the uplink carrier 203 according to the soft combination of command TPC₁ received on the F-DPCH of the anchor downlink carrier 201 (referred to as TPC_{1A}) and command TPC₁ received on the F-DPCH of the non-anchor downlink carrier 202 (referred to as TPC_{1NA}) as follows: TPC₁ combined=a1*TPC_{1A}+a2*TPC_{1NA}, where a1 and a2 are real valued weight factors which can be either fixed or set according to estimated downlink channel conditions on respective carrier. FIG. 2f also illustrates the soft handover situation, with a TPC command TPC_{1SHO} received on the two downlink carriers 205, 206 of a soft handover NodeB. In this case, the UE combines the TPC command received from the soft handover NodeB TPC_{1SHO} and from the serving NodeB TPC₁ according to the “or of down” rule, either before or after the soft combination of the TPC commands of the different downlink carriers.

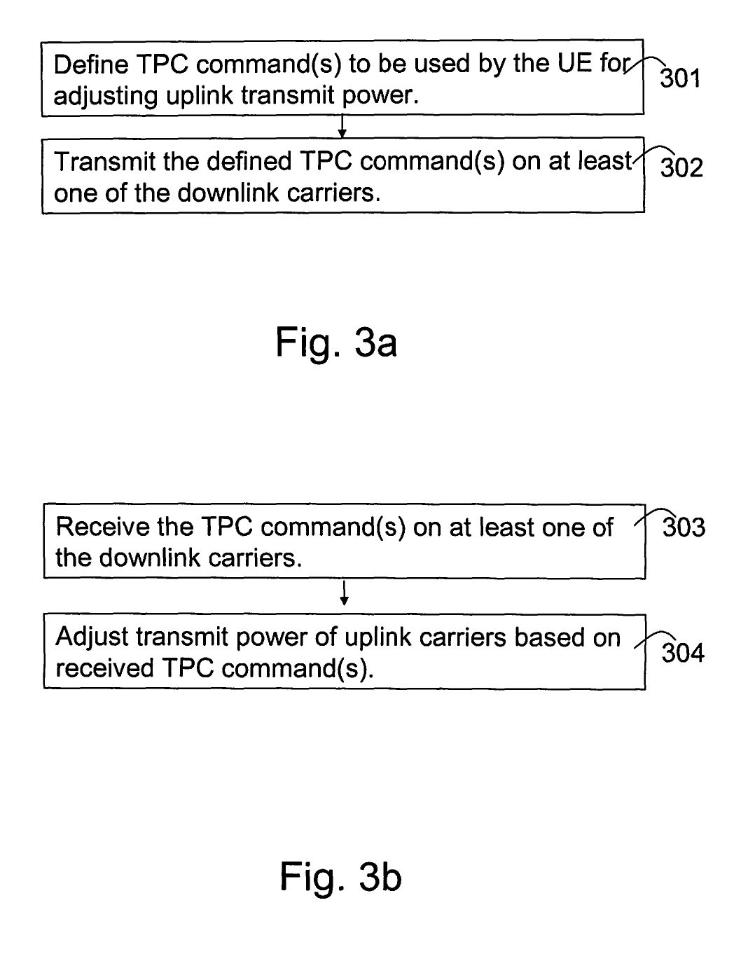

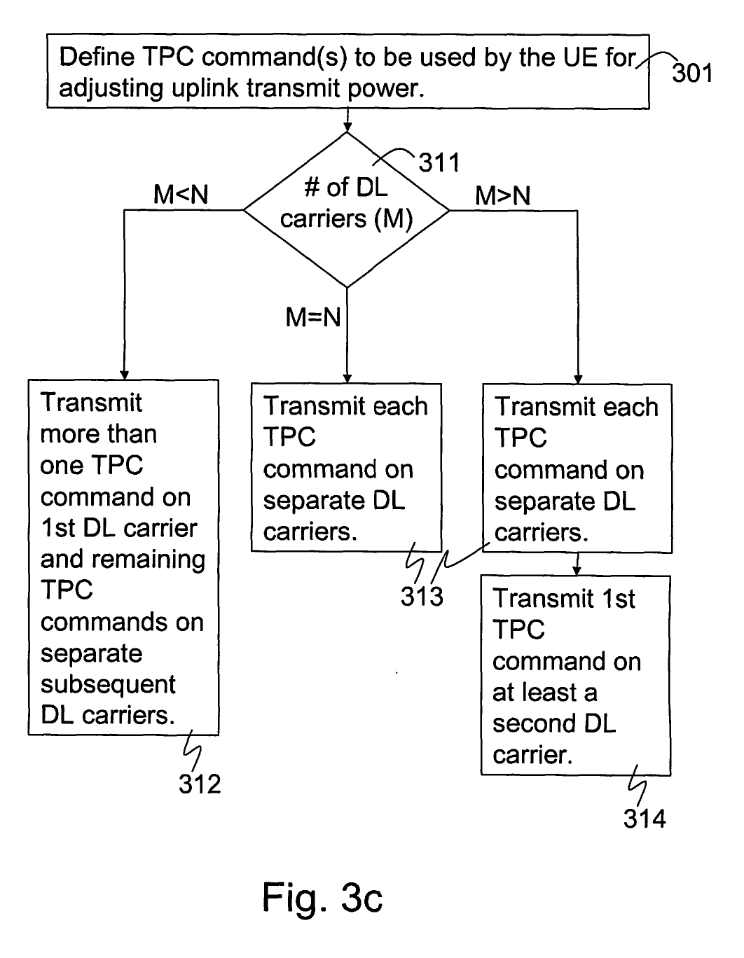

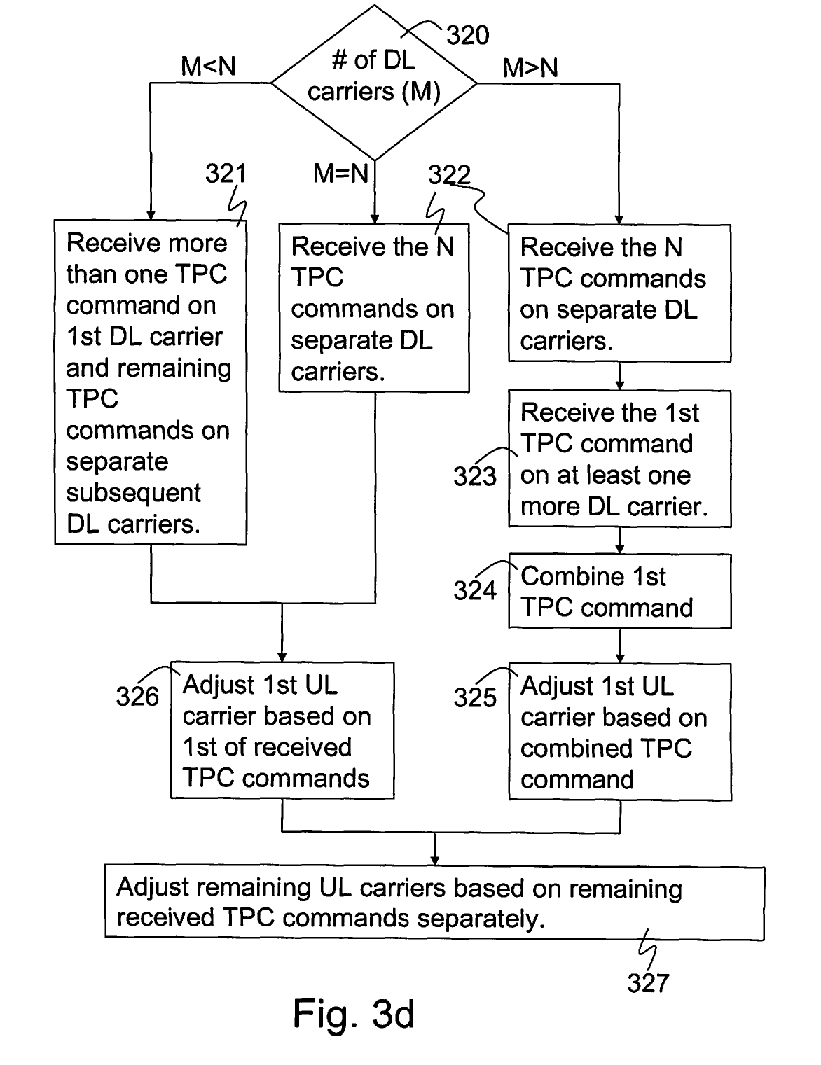

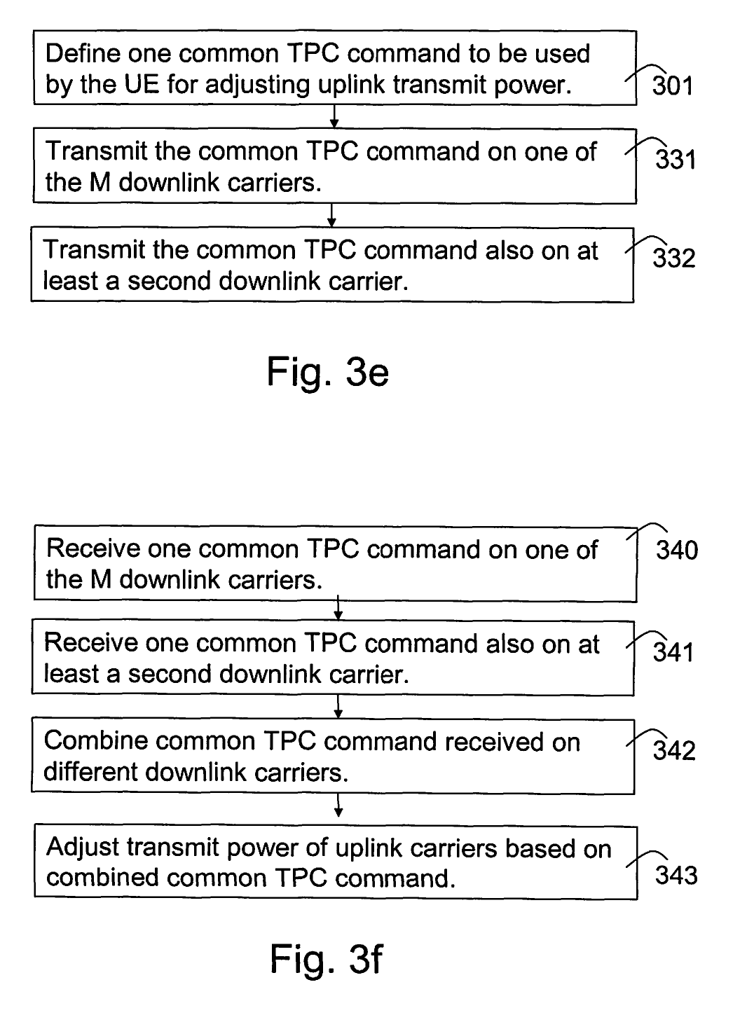

FIG. 3a is a flowchart of the method for the NodeB, according to one embodiment of the present invention. In step 301 the NodeB defines at least one TPC command to be used by the user equipment for adjusting the transmit power of the uplink carriers. In the next step 302 the NodeB transmits the defined TPC command(s) on at least one of the downlink carriers.

Furthermore, FIG. 3b is a flowchart of the method for the UE, according to one embodiment of the present invention. In step 303, the UE receives the TPC command(s) on at least one of the downlink carriers, from the NodeB. In the next step 304 the UE adjusts the transmit power of the uplink carriers based on the received TPC command(s).

FIG. 3c is a flowchart of the method for the NodeB, according to one example of alternative embodiment 1 above. In step 301 the NodeB defines N TPC commands to be used by the user equipment for adjusting the transmit power of the N uplink carriers respectively. Depending on the multi-carrier symmetry, i.e. the number of downlink carriers M 311 in relation to the number of uplink carriers or TPC commands N, the step of transmitting 302 the N TPC commands comprises the sub step:
M<N: Transmitting, in step 312, more than one TPC commands on the first downlink carrier and the remaining TPC commands on separate subsequent downlink carriers. This is done in order to fit all N TPC commands onto the M downlink carriers.
M=N: Transmitting, in step 313, each TPC command on a separate downlink carrier.
M>N: Transmitting, in step 313, each TPC command on a separate downlink carrier and transmitting, in step 314, a first of the N TPC commands on at least one more downlink carrier. This is done in order to enhance the reliability of the power control for the first uplink carrier in case of frequency selective downlink channel conditions (carriers need not to be adjacent in the frequency band). This first TPC command could for example be the TPC command corresponding to the uplink anchor carrier. It is also possible to only transmit each TPC command on a separate downlink carrier, as in step 313 above. Some downlink carriers will then not carry any TPC commands thus saving signaling capacity.

Furthermore, FIG. 3d is a flowchart of the method for the UE, according to one example of alternative embodiment 1 above. The step 303 of receiving (see FIG. 3b) the N TPC commands will in this embodiment also depend on the multi-carrier symmetry, i.e. the number of downlink carriers M, determined in step 320, in relation to the number of uplink carriers or TPC commands N, and will thus comprise the following sub step:
M<N: Receiving, in step 321, more than one TPC commands on the first downlink carrier and the remaining TPC commands on separate subsequent downlink carriers. The first TPC command can in this case be used to adjust, in step 326, the transmit power of the first uplink carrier without any combining step.
M=N: Receiving, in step 322, each TPC command on a separate downlink carrier. Also in this case the first TPC command can be used to adjust, in step 326, the transmit power of the first uplink carrier without any combining step.
M>N: Also here each TPC command is received on a separate downlink carrier as in step 322, but the first of the N TPC commands is also received, in step 323, on more than one downlink carrier. A combination step 324 is thus needed before the step of adjusting 325 the transmit power of the first uplink carrier based on the combined TPC command.

The last step 327 is the adjustment of the transmit power of the remaining uplink carriers based on the remaining received TPC commands separately, which is thus done regardless of if M is larger than, equal to or smaller than N.

FIG. 3e is a flowchart of the method for the NodeB, according to alternative embodiment 2 above, when the number of downlink carriers M is larger than one. In step 301 the NodeB defines one common TPC command to be used by the user equipment for adjusting the transmit power of the N uplink carriers. This definition of a common TPC command can be done according to either the first alternative embodiment A or the second alternative embodiment B described above. The NodeB then transmits, in step 331, the common TPC command on one of the M downlink carriers, and in order to enhance the reliability of the power control for the first uplink carrier in case of frequency selective downlink channel conditions, it also transmits, in step 332, the common TPC command on at least a second downlink carrier.

Furthermore, FIG. 3f is a flowchart of the method for the UE, according to alternative embodiment 2 above, when the number of downlink carriers M is larger than one. In step 340, the UE receives the common TPC command on one of the M downlink carriers, from the NodeB. However it also receives, in step 341, the common TPC command on at least a second downlink carrier. This means that the UE must combine, in step 342, the TPC commands received on the different downlink carriers, before it can adjust, in step 343, the transmit power of the uplink carriers based on the combined common TPC command.

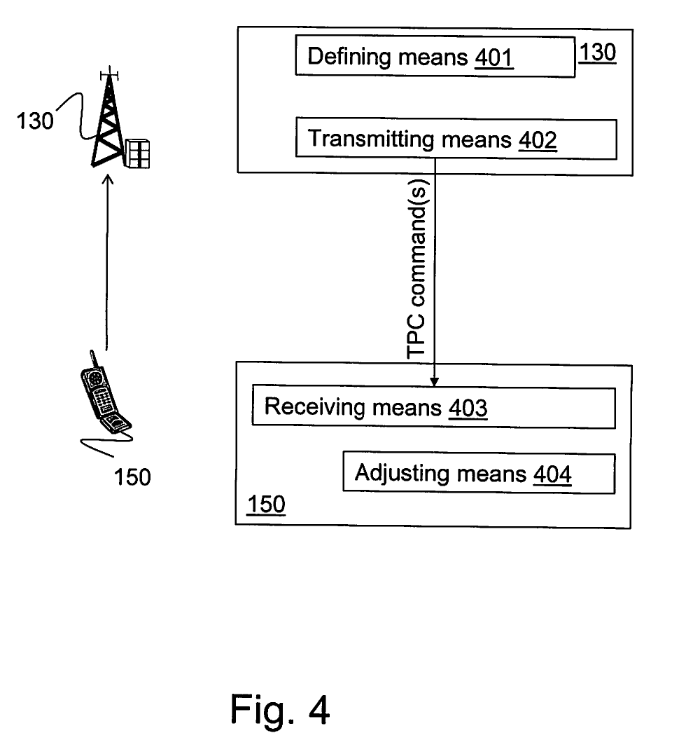

Schematically illustrated in FIG. 4 and according to one embodiment, the NodeB 130 comprises means for defining 401 one or more TPC commands to be used by the user equipment for adjusting the transmit power of the uplink carriers. It also comprises means for transmitting 402 the defined TPC command(s) on the downlink carriers.

Also illustrated in FIG. 4 is the UE 150. It comprises means for receiving 403 one or more TPC commands on the downlink carriers from one or more NodeBs. It also comprises means for adjusting 404 the transmit power of the uplink carriers based on the received TPC command(s).

It should be noted that the means illustrated in FIG. 4 may be implemented by physical or logical entities using software functioning in conjunction with a programmed microprocessor or general purpose computer, and/or using an application specific integrated circuit (ASIC).

The above mentioned and described embodiments are only given as examples and should not be limiting to the present invention. Other solutions, uses, objectives, and functions within the scope of the invention as claimed in the accompanying patent claims should be apparent for the person skilled in the art.

1. A method of uplink transmit power control in a radio base station of a multi-carrier wireless communication system, wherein the radio base station receives on N uplink carriers and transmits on M downlink carriers in the communication with at least one user equipment, and wherein the sum of N and M is equal to or larger than three, said method characterised by the steps of
defining (301) at least one transmit power control, TPC, command to be used by one of said user equipment for adjusting the transmit power of the N uplink carriers, the number of defined TPC commands being equal to or lower than N, and
transmitting (302) the defined at least one TPC command on at least one of the M downlink carriers.

2. The method according to claim 1, wherein said at least one TPC command is transmitted on at least one downlink control channel of said M downlink carriers.

3. The method according to claim 2, wherein said downlink control channel is a fractional downlink physical control channel, F-DPCH.

4. The method according to any of claims 1-3, wherein the number of said at least one TPC command is equal to N, and wherein the step of transmitting (302) said N TPC commands on at least one of the M downlink carriers depends on the number of downlink carriers M and comprises the sub step of
transmitting (312) both a first and at least a second of said N TPC commands on a first downlink carrier and each of the remaining TPC commands on separate subsequent downlink carriers, in order to fit all N TPC commands onto the M downlink carriers when M is smaller than N, and
transmitting (313) each of said N TPC commands on separate downlink carriers, when M is larger than or equal to N.

5. The method according to claim 4, wherein the step of transmitting (302) said N TPC commands on at least one of the M downlink carriers comprises the additional sub step of transmitting (314) a first of said N TPC commands also on at least a second downlink carrier, in order to increase the reliability of the first of said N TPC commands when M is larger than N.

6. The method according to any of claims 1-3, wherein said at least one TPC command is one common TPC command, and wherein the step of transmitting (302) said common TPC command on at least one of the M downlink carriers comprises the sub step of transmitting (331) said common TPC command on one of the M downlink carriers.

7. The method according to claim 6, wherein the step of transmitting (302) said common TPC command on at least one of the M downlink carriers comprises the additional sub step of transmitting (332) said common TPC command also on at least a second downlink carrier, when M is larger than one.

8. The method according to any of claims 6-7, wherein the step of defining said common TPC command comprises the sub step of selecting a TPC command valid for one of the N uplink carriers as said common TPC command.

9. The method according to any of claims 6-7, wherein the step of defining said common TPC command comprises the sub step of combining TPC commands valid for the individual N uplink carriers, according to a pre-defined combination rule.

10. The method according to claim 9, wherein the pre-defined combination rule results in a common TPC command that indicates power up when each of the TPC commands valid for the individual N uplink carriers indicate power up, and power down when at least one of the TPC commands valid for the individual N uplink carriers indicates power down.

11. The method according to claim 9, wherein the pre-defined combination rule results in a common TPC command that indicates power down when each of the TPC commands valid for the individual N uplink carriers indicate power down, and power up when at least one of the TPC commands valid for the individual N uplink carriers indicates power up.

12. A method of uplink transmit power control in a user equipment of a multi-carrier wireless communication system, wherein the user equipment transmits on N uplink carriers and receives on M downlink carriers in the communication with at least one radio base station, and wherein the sum of N and M is equal to or larger than three, said method characterised by the steps of
receiving (303) at least one TPC command on at least one of the M downlink carriers from at least one radio base station, the number of received TPC commands being equal to or lower than N, and
adjusting (304) the transmit power of the N uplink carriers based on the received at least one TPC command.

13. The method according to claim 12, wherein said at least one TPC command is received on at least one downlink control channel of said M downlink carriers.

14. The method according to claim 13, wherein said downlink control channel is a fractional downlink physical control channel, F-DPCH.

15. The method according to any of claims 12-14, wherein the number of said at least one TPC command is equal to N, and wherein the step of receiving (303) said N TPC commands on at least one of the M downlink carriers comprises the sub step of
receiving (321) both the first and at least a second of said N TPC commands on a first downlink carrier and each of the remaining TPC commands on separate subsequent downlink carriers from at least one radio base station, when M is smaller than N, and
receiving (322) the N TPC commands on separate downlink carriers from at least one radio base stations, when M is larger than or equal to N.

16. The method according to claim 15, wherein the step of adjusting (304) the transmit power of the N uplink carriers comprises the sub step of adjusting the transmit power of each of the uplink carriers based on each of the received N TPC commands separately.

17. The method according to claim 15, wherein the step of receiving (303) said N TPC commands on at least one of the M downlink carriers comprises the additional sub step of receiving (323) a first of said N TPC commands also on at least a second downlink carrier when M is larger than N, and wherein the step of adjusting (304) the transmit power of the N uplink carriers comprises the sub steps of
combining (324) the first of said N TPC commands received on the first downlink carrier and on at least a second downlink carrier according to a soft combining rule, when M is larger than N,
adjusting (325) the transmit power of the first uplink carrier based on the combined TPC command when M is larger than N,
adjusting (326) the transmit power of the first uplink carrier based on the first of the received N TPC commands when M is equal to or smaller than N, and
adjusting (327) the transmit power of each of the remaining uplink carriers based on the remaining received TPC commands separately.

18. The method according to claim 17, comprising, when M is larger than N and when the number of said at least one radio base station is at least two, the additional sub step of combining each of said N TPC commands received from said at least two radio base stations according to a pre-defined combination rule, before the sub step of combining the first of said N TPC commands received on more than one carrier.

19. The method according to claim 17, comprising, when M is larger than N and when the number of said at least one radio base station is at least two, the additional sub step of combining each of said N TPC commands received from said at least two radio base stations according to a pre-defined combination rule, after the sub step of combining the first of said N TPC commands received on more than one carrier.

20. The method according to any of claims 18-19, wherein the pre-defined combination rule results in a combined TPC command that indicates power up when each of said N TPC commands from all of said at least two radio base stations indicate power up, and power down when at least one of each of said N TPC commands from all of said at least two radio base stations indicates power down.

21. The method according to any of claims 12-14, wherein said at least one TPC command is one common TPC command, and wherein the step of receiving (303) said common TPC command on at least one of the M downlink carriers comprises the sub step of
receiving (340) said common TPC command on one of the M downlink carriers from at least one radio base station.

22. The method according to claim 21, wherein the step of adjusting the transmit power comprises the sub step of adjusting the transmit power of the N uplink carriers based on said common TPC command.

23. The method according to claim 21, wherein the step of receiving (303) said common TPC command on at least one of the M downlink carriers comprises the additional sub step of also receiving (341) said common TPC command on at least a second of the M downlink carriers from at least one radio base station, and wherein the step of adjusting (304) the transmit power comprises the sub steps of
combining (342) each of said common TPC command received on one and on at least a second of the M downlink carriers into a combined common TPC command according to a soft combining rule, and
adjusting (343) the transmit power of the N uplink carriers based on the combined common TPC command.

24. The method according to claim 23, comprising, when the number of said at least one radio base station is at least two, the additional sub step of combining each of said common TPC command received from said at least two radio base stations according to a pre-defined combination rule, after the sub step of combining each of said common TPC command received on more than one carrier.

25. The method according to claim 23, comprising, when the number of said at least one radio base station is at least two, the additional sub step of combining each of said common TPC command received from said at least two radio base stations according to a pre-defined combination rule, before the sub step of combining each of said common TPC command received on more than one carrier.

26. The method according to any of claims 24-25, wherein the pre-defined combination rule results in a combined common TPC command that indicates power up when each of said common TPC command received from said at least two radio base stations indicate power up, and power down when at least one of each of said common TPC command received from said at least two radio base stations indicates power down.

27. A radio base station (130) of a multi-carrier wireless communication system, wherein the radio base station is arranged to receive on N uplink carriers and transmit on M downlink carriers in the communication with at least one user equipment, and wherein the sum of N and M is equal to or larger than three, said radio base station characterised in that it comprises
means for defining (401) at least one transmit power control, TPC, command to be used by one of said user equipment for adjusting the transmit power of the N uplink carriers, the number of defined TPC commands being equal to or lower than N, and
means for transmitting (402) the defined at least one TPC command on at least one of the M downlink carriers.

28. The radio base station according to claim 27, wherein the number of said at least one TPC command is equal to N and wherein the means for transmitting said N TPC commands on at least one of the M downlink carriers further comprises
means for transmitting both a first and at least a second of said N TPC commands on a first downlink carrier and each of the remaining TPC commands on separate subsequent downlink carriers, in order to fit all N TPC commands onto the M downlink carriers when M is smaller than N, and
means for transmitting each of said N TPC commands on separate downlink carriers, when M is larger than or equal to N.

29. The radio base station according to claim 28, wherein the means for transmitting said N TPC commands on at least one of the M downlink carriers also comprises means for transmitting a first of said N TPC commands also on at least a second downlink carrier, in order to increase the reliability of the first of said N TPC commands when M is larger than N.

30. The radio base station according to claim 27, wherein said at least one TPC command is one common TPC command, and wherein the means for transmitting said common TPC command on at least one of the M downlink carriers further comprises
means for transmitting said common TPC command on one of the M downlink carriers.

31. The radio base station according to claim 30, wherein the means for transmitting said common TPC command on at least one of the M downlink carriers also comprises means for transmitting said common TPC command also on at least a second downlink carrier, when M is larger than one.

32. The radio base station according to any of claims 30-31, wherein the means for defining said common TPC command further comprises means for selecting a TPC command valid for one of the N uplink carriers as said common TPC command.

33. The radio base station according to any of claims 30-31, wherein the means for defining said common TPC command further comprises means for combining TPC commands valid for the individual N uplink carriers, according to a pre-defined combination rule.

34. The radio base station according to claim 33, wherein the pre-defined combination rule results in a common TPC command that indicates power up when each of the TPC commands valid for the individual N uplink carriers indicate power up, and power down when at least one of the TPC commands valid for the individual N uplink carriers indicates power down.

35. The radio base station according to claim 33, wherein the pre-defined combination rule results in a common TPC command that indicates power down when each of the TPC commands valid for the individual N uplink carriers indicate power down, and power up when at least one of the TPC commands valid for the individual N uplink carriers indicates power up.

36. A user equipment (150) of a multi-carrier wireless communication system, wherein the user equipment is arranged to transmit on N uplink carriers and receive on M downlink carriers in the communication with at least one radio base station, and wherein the sum of N and M is equal to or larger than three, said user equipment characterised in that it comprises
means for receiving (403) at least one TPC command on at least one of the M downlink carriers from at least one radio base station, the number of received TPC commands being equal to or lower than N, and
means for adjusting (404) the transmit power of the N uplink carriers based on the received at least one TPC command.

37. The user equipment according to claim 36, wherein the number of said at least one TPC command is equal to N, and wherein the means for receiving said N TPC commands on at least one of the M downlink carriers further comprises
means for receiving both the first and at least a second of said N TPC commands on a first downlink carrier and each of the remaining TPC commands on separate subsequent downlink carriers from at least one radio base station, when M is smaller than N, and
means for receiving the N TPC commands on separate downlink carriers from at least one radio base stations, when M is larger than or equal to N.

38. The user equipment according to claim 37, wherein the means for adjusting the transmit power of the N uplink carriers further comprises means for adjusting the transmit power of each of the uplink carriers based on each of the received N TPC commands separately.

39. The user equipment according to claim 37, wherein the means for receiving said N TPC commands on at least one of the M downlink carriers also comprises means for receiving a first of said N TPC commands also on at least a second downlink carrier, when M is larger than N, and wherein the means for adjusting the transmit power of the N uplink carriers further comprises
means for combining the first of said N TPC commands received both on the first downlink carrier and on at least a second downlink carrier according to a soft combining rule, when M is larger than N,
means for combining each TPC command received from at least two radio base stations according to a predefined combination rule,
means for adjusting the transmit power of the first uplink carrier based on the combined TPC command when M is larger than N,
means for adjusting the transmit power of the first uplink carrier based on the first of the received N TPC commands when M is equal to or smaller than N, and
means for adjusting the transmit power of each of the remaining uplink carriers based on the remaining received TPC commands separately.

40. The user equipment according to claim 39, wherein the pre-defined combination rule results in a combined TPC command that indicates power up when each of said N TPC commands from all of said at least two radio base stations indicate power up, and power down when at least one of each of said N TPC commands from all of said at least two radio base stations indicates power down.

41. The user equipment according to claim 36, wherein said at least one TPC command is one common TPC command, and wherein the means for receiving said common TPC command on at least one of the M downlink carriers further comprises
means for receiving said common TPC command on one of the M downlink carriers from at least one radio base station.

42. The user equipment according to claim 41, wherein the means for adjusting the transmit power further comprises means for adjusting the transmit power of the N uplink carriers based on said common TPC command.

43. The user equipment according to claim 41, wherein the means for receiving said common TPC command on at least one of the M downlink carriers also comprises means for receiving said common TPC command on at least a second of the M downlink carriers from at least one radio base station, and wherein the means for adjusting the transmit power further comprises
means for combining each of said common TPC command received on one and on at least a second of the M downlink carriers into a combined common TPC command according to a soft combining rule,
means for combining each TPC command received from at least two radio base stations according to a pre-defined combination rule, and
means for adjusting the transmit power of the N uplink carriers based on the combined common TPC command.

44. The user equipment according to claim 43, wherein the pre-defined combination rule results in a combined common TPC command that indicates power up when each of said common TPC command received from said at least two radio base stations indicate power up, and power down when at least one of each of said common TPC command received from said at least two radio base stations indicates power down.
